(19) United States
(12) Patent Application Publication
(10) Pub. No.: US 2022/0198229 A1
(43) Pub. Date: Jun. 23, 2022

(54) SYSTEMS AND METHODS RELATED TO APPLIED ANOMALY DETECTION AND CONTACT CENTER COMPUTING ENVIRONMENTS

(71) Applicant: Genesys Telecommunications Laboratories, Inc., Daly City, CA (US)

(72) Inventors: José Oñate López, Daly City, CA (US); Luis Ignacio Lamprea, Daly City, CA (US)

(21) Appl. No.: 17/557,580

(22) Filed: Dec. 21, 2021

Related U.S. Application Data
(60) Provisional application No. 63/128,277, filed on Dec. 21, 2020.

(51) Int. Cl. G06K 9/62; H04L 43/067; G06N 20/00

(52) U.S. Cl. CPC G06K 9/6284; G06K 9/6273; G06N 20/00; H04L 43/067; G06K 9/6298

(57) ABSTRACT

A system for detecting anomalies in metric data provided by one or more customers according to an embodiment includes at least one processor and at least one memory comprising a plurality of instructions stored thereon that, in response to execution by the at least one processor, causes the system to receive metric data indicative of a plurality of time-series based observations for a particular customer metric, to define, based on the metric data, a plurality of parameters to characterize one or more spheres each configured to capture a number of time-series based observations for the particular customer metric, and to generate, based on the plurality of parameters, the one or more spheres to determine coverage of the metric data within the one or more spheres and detect one or more anomalies in the metric data.

### CROSS-REFERENCE TO RELATED APPLICATIONS

This application claims priority to U.S. Provisional Patent Application Ser. No. 63/128,277 filed on Dec. 21, 2020, the contents of which are incorporated herein by reference in their entirety.

### BACKGROUND

Data analysis may involve detecting anomalies in various data sets. In some cases, anomaly detection may entail evaluating whether a new observation belongs to the same distribution as previous observations or should be classified as an outlier. Various systems and methodologies for anomaly detection suffer from a number of drawbacks. Accordingly, development of alternative systems and methods for anomaly detection remains an area of interest.

### SUMMARY

One embodiment is directed to a unique system, components, and methods for detecting anomalies in metric data provided by one or more customers. Other embodiments are directed to apparatuses, systems, devices, hardware, methods, and combinations thereof for detecting anomalies in data provided by one or more customers.

According to an embodiment, a system for detecting anomalies in metric data provided by one or more customers may include at least one processor and at least one memory comprising a plurality of instructions stored thereon that, in response to execution by the at least one processor, causes the system to receive metric data indicative of a plurality of time-series based observations for a particular customer metric, to define, based on the metric data, a plurality of parameters to characterize one or more spheres each configured to capture a number of time-series based observations for the particular customer metric, and to generate, based on the plurality of parameters, the one or more spheres to determine coverage of the metric data within the one or more spheres and detect one or more anomalies in the metric data. To generate the one or more spheres based on the plurality of parameters may include to dynamically generate a plurality of spheres each having a radius that varies based on the plurality of time-series based observations for the particular customer metric.

In some embodiments, to define the plurality of parameters based on the metric data may include to define a minimum radius for generation of at least one sphere, to define a radius increment for generation of one or more new spheres each having a varying radius, and to define a coverage limit indicative of a maximum number of metric data points to be covered by the generated spheres.

In some embodiments, to generate the one or more spheres based on the plurality of parameters may include to determine a location corresponding to a maximum concentration of metric data based on the minimum radius.

In some embodiments, to generate the one or more spheres based on the plurality of parameters may include to determine whether the coverage limit has been reached and to increment a radius for generation of at least one new sphere based on the radius increment in response to a determination that the coverage limit has not been reached.

In some embodiments, to generate the one or more spheres based on the plurality of parameters may include to determine whether the at least one new sphere provides coverage of the metric data not previously provided and to filter out metric data already covered by a previous sphere in response to a determination that the at least one new sphere does not provide coverage of the metric data not previously provided.

In some embodiments, to generate the one or more spheres based on the plurality of parameters may include to update the minimum radius in response to a determination that the at least one new sphere provides coverage of the metric data not previously provided and to update the location in response to the determination that the at least one new sphere provides coverage of the metric data not previously provided.

In some embodiments, to generate the one or more spheres based on the plurality of parameters may include to determine another location corresponding to the maximum concentration of metric data based on the minimum radius of the at least one sphere and a distance between the at least one sphere and at least one nearest neighboring sphere and to generate at least one new sphere such that a center of the at least one new sphere is positioned at the another location.

In some embodiments, to generate the one or more spheres based on the plurality of parameters may include to compare coverage of the metric data provided by the at least one sphere to coverage of the metric data provided by the at least one nearest neighboring sphere or the at least one new sphere and to select whichever sphere provides the greatest coverage of the metric data based on the comparison for generation of another new sphere.

In some embodiments, to define the plurality of parameters based on the metric data may include to filter out outliers from the metric data and to define the coverage limit based at least partially on the filtered metric data.

According to another embodiment, one or more non-transitory machine-readable storage media may include a plurality of instructions stored thereon that, in response to execution by at least one processor, causes a system to receive metric data indicative of a plurality of time-series based observations for a particular customer metric, to define, based on the metric data, a plurality of parameters to characterize one or more spheres each configured to capture a number of time-series based observations for the particular customer metric, and to generate, based on the plurality of parameters, the one or more spheres to determine coverage of the metric data within the one or more spheres and detect one or more anomalies in the metric data. To generate the one or more spheres based on the plurality of parameters may include to dynamically generate a plurality of spheres each having a radius that varies based on the plurality of time-series based observations for the particular customer metric.

In some embodiments, to define the plurality of parameters based on the metric data may include to define a minimum radius for generation of at least one sphere, to define a radius increment for generation of one or more new spheres each having a varying radius, and to define a coverage limit indicative of a maximum number of metric data points to be covered by the generated spheres.

In some embodiments, to generate the one or more spheres based on the plurality of parameters may include to determine a location corresponding to a maximum concentration of metric data based on the minimum radius.

In some embodiments, to generate the one or more spheres based on the plurality of parameters may include to determine whether the coverage limit has been reached and to increment a radius for generation of at least one new sphere based on the radius increment in response to a determination that the coverage limit has not been reached.

In some embodiments, to generate the one or more spheres based on the plurality of parameters may include to determine whether the at least one new sphere provides coverage of the metric data not previously provided and to filter out metric data already covered by a previous sphere in response to a determination that the at least one new sphere does not provide coverage of the metric data not previously provided.

In some embodiments, to generate the one or more spheres based on the plurality of parameters may include to update the minimum radius in response to a determination that the at least one new sphere provides coverage of the metric data not previously provided and to update the location in response to the determination that the at least one new sphere provides coverage of the metric data not previously provided.

In some embodiments, to define the plurality of parameters based on the metric data may include to filter out outliers from the metric data and to define the coverage limit based at least partially on the filtered metric data.

According to yet another embodiment, a method of detecting anomalies in metric data provided by one or more customers may include receiving, by a contact center system or a compute device, metric data indicative of a plurality of time-series based observations for a particular customer metric, defining, by the contact center system or the compute device based on the metric data, a plurality of parameters to characterize one or more spheres each configured to capture a number of time-series based observations for the particular customer metric, and generating, by the contact center system or the compute device based on the plurality of parameters, the one or more spheres to determine coverage of the metric data within the one or more spheres and detect one or more anomalies in the metric data. Generating the one or more spheres based on the plurality of parameters may include dynamically generating, by the contact center system or the compute device, a plurality of spheres each having a radius that varies based on the plurality of time-series based observations for the particular customer metric.

In some embodiments, defining the plurality of parameters based on the metric data may include defining, by the contact center system or the compute device, a minimum radius for generation of at least one sphere, defining, by the contact center system or the compute device, a radius increment for generation of one or more new spheres each having a varying radius, and defining, by the contact center system or the compute device, a coverage limit indicative of a maximum number of metric data points to be covered by the generated spheres.

In some embodiments, generating the one or more spheres based on the plurality of parameters may include determining, by the contact center system or the compute device, a location corresponding to a maximum concentration of metric data based on the minimum radius.

In some embodiments, generating the one or more spheres based on the plurality of parameters may include determining, by the contact center system or the compute device, whether the coverage limit has been reached and incrementing, by the contact center system or the compute device, a radius for generation of at least one new sphere based on the radius increment in response to a determination that the coverage limit has not been reached.

This summary is not intended to identify key or essential features of the claimed subject matter, nor is it intended to be used as an aid in limiting the scope of the claimed subject matter. Further embodiments, forms, features, and aspects of the present application shall become apparent from the description and figures provided herewith.

### BRIEF DESCRIPTION OF THE DRAWINGS

The concepts described herein are illustrative by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a contact center system;

FIG. 2 is a simplified block diagram of at least one embodiment of a computing device;

FIG. 3 is a simplified flowchart of at least one embodiment of a method of detecting anomalies in data provided by one or more customers;

FIG. 4 is a simplified flowchart of another embodiment of a method of detecting anomalies in data provided by one or more customers;

FIG. 5 is a simplified flowchart of at least one embodiment of a method of generating one or more spheres which may be performed during sphere generation of the method of FIG. 4;

FIG. 6 is a visual representation of a collection of metric data points/observations;

FIG. 7 is a visual representation of the collection of metric data points/observations with a sphere generated according to the method of FIG. 5;

FIG. 8 is a visual representation of the collection of metric data points/observations with two spheres generated according to the method of FIG. 5;

FIG. 9 is a visual representation of the collection of metric data points/observations with three spheres generated according to the method of FIG. 5;

FIG. 10 is a visual representation of the collection of metric data points/observations with a plurality of spheres generated according to a comparative method;

FIG. 11 is a visual representation of the collection of metric data points/observations with a plurality of spheres generated according to the method of FIG. 5;

FIG. 12 is a visual representation of a performance evaluation for various algorithms/models for detecting anomalies in various data sets;

FIG. 13 is a visual representation of a collection of metric data with spheres generated according to a comparative method;

FIG. 14 is a visual representation of the collection of metric data of FIG. 13 with spheres generated according to the method of FIG. 5;

FIG. 15 is a visual representation of a collection of metric data with spheres generated according to a comparative method;

FIG. 16 is a visual representation of the collection of metric data of FIG. 15 with spheres generated according to the method of FIG. 5;

FIG. 17 is a graphical depiction of anomaly detection information for a metric obtained according to a comparative method; and

FIG. 18 is a graphical depiction of anomaly detection information for a metric obtained according to the method of FIG. 5.

### DETAILED DESCRIPTION

Although the concepts of the present disclosure are susceptible to various modifications and alternative forms, specific embodiments have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. It should be further appreciated that although reference to a “preferred” component or feature may indicate the desirability of a particular component or feature with respect to an embodiment, the disclosure is not so limiting with respect to other embodiments, which may omit such a component or feature. Further, when a particular feature, structure, or characteristic is described in connection with an embodiment, it is submitted that it is within the knowledge of one skilled in the art to implement such feature, structure, or characteristic in connection with other embodiments whether or not explicitly described. Further, particular features, structures, or characteristics may be combined in any suitable combinations and/or sub-combinations in various embodiments.

Additionally, it should be appreciated that items included in a list in the form of “at least one of A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C). Further, with respect to the claims, the use of words and phrases such as “a,” “an,” “at least one,” and/or “at least one portion” should not be interpreted so as to be limiting to only one such element unless specifically stated to the contrary, and the use of phrases such as “at least a portion” and/or “a portion” should be interpreted as encompassing both embodiments including only a portion of such element and embodiments including the entirety of such element unless specifically stated to the contrary.

The disclosed embodiments may, in some cases, be implemented in hardware, firmware, software, or a combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures unless indicated to the contrary. Additionally, the inclusion of a structural or method feature in a particular figure is not meant to imply that such feature is required in all embodiments and, in some embodiments, may not be included or may be combined with other features.

For the purposes of data collection and/or data analysis, in some applications, it may be informative to ascertain whether a new observation/data point belongs to the same data distribution as existing observations/data points. Observation(s) which belong to the same data distribution as exiting observations may be referred to herein as inliers, whereas observation(s) that do not belong to the same distribution as existing observations may be referred to herein as outliers. The ability to distinguish between inliers and outliers may be particularly useful for cleaning real data sets.

It should be appreciated that in many cases, outliers contained in data (e.g., training data) may be defined as observation(s) that are far from the others based on one or more visual representations of the data. Therefore, in some cases, outlier detection estimators may strive to fit and/or capture regions where the data is most concentrated, while typically neglecting the deviant observations or outliers.

In some cases, however, outliers may not already be present in the data of interest. In those cases, it may be beneficial to detect whether a new observation is an outlier. A new observation that is detected to be an outlier may be said to be a novelty, at least in some embodiments. Additionally, the detection of such outliers may be referred to herein as novelty detection.

Outlier detection and novelty detection may be performed to detect anomalies in data, particularly in the event that detection of abnormal or unusual observations is desirable. In some cases, outlier detection may be referred to as “unsupervised anomaly detection,” whereas novelty detection may be referred to as “semi-supervised anomaly detection.” In the context of outlier detection, because estimators often assume that outliers/anomalies are located in low density/concentration regions, the outliers/anomalies typically cannot form a dense cluster. However, in the context of novelty detection, novelties/anomalies may form a dense cluster so long as they are located in a low density/concentration region of the data, which may be considered to be normal.

The systems and methods of the present disclosure are configured to implement a model hereinafter referred to as the INS (Isolation Nearest Spheres) model. It should be appreciated that the INS model is derived from, and inspired by, the need to visualize how systems, methods, and/or tools used to implement the model learn different behaviors for different metrics. Even more, the INS model relies on visual representations and/or graphical depictions which may be used to detect and evaluate the severity of anomalies. As a result, anomaly detection for time series observations may be considered as analogous to, or otherwise informed by, outlier detection in multivariable systems. To associate anomaly detection for time serious observations with outlier detection in multivariable systems, the present disclosure envisions extraction of useful features from time series data that help describe the continuous behavior of various metrics and are sensitive to outliers.

In some embodiments, the present disclosure provides a machine learning algorithm for detecting anomalies in any time-series metric data that produces a model. In some cases, the anomaly detection model contemplated herein is unsupervised and does not require any parameter definition to learn normal behaviors from the metric data. Additionally, in some cases, behaviors learned from the metric data are based on knowledge spheres each having a dynamic radius in one or more high density regions.

In some embodiments, the present disclosure contemplates a feature selection process or mechanism for time-series based observations for various metrics. That process may include consideration of (visual) representation of the time-series based metric data, sensitivity to outliers in the data, and standardization of the data (e.g., ensuring dimensional capability of data sets). In view of those considerations, the number (e.g., n) of features selected and/or determined according to the techniques of the present disclosure are based on the current value/observation for a particular metric and historical values/observations for that metric (e.g., observations received within a previous hour or a previous day). In some embodiments, the n features contemplated by the present disclosure may include, but are not limited to, metric values, derivatives, and moving averages.

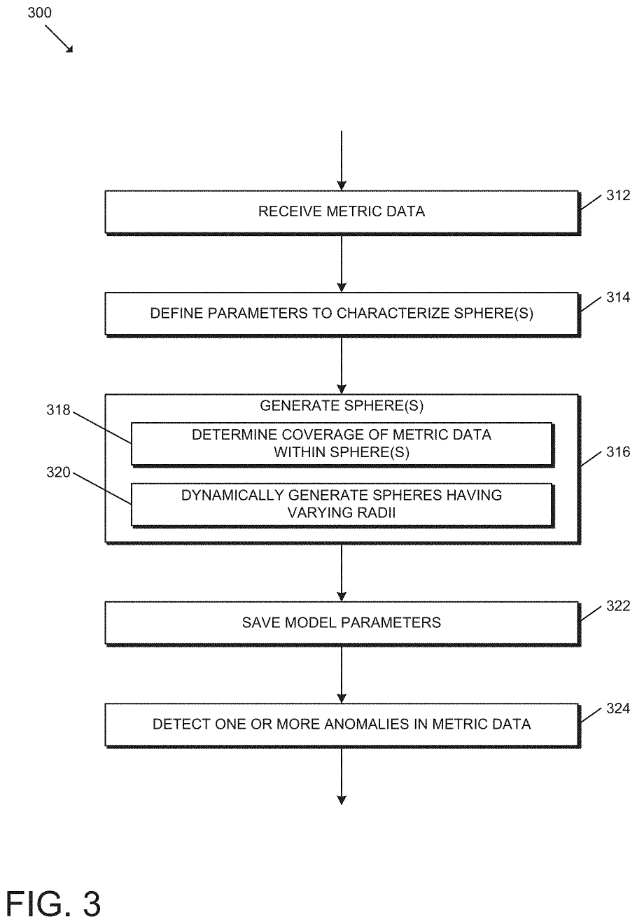

For the purposes of the present disclosure, the definitions provided below are applicable to subsequent discussion of the defined terms.
Isolation—reduction (i.e., performed by the INS model) of data into specific knowledge units. Such reduction is performed to reach a knowledge limit.
Nearest—the INS model relies on nearest neighbor distance to determine proximity between data points. Those distances are refined and/or improved using data associated with only non-covered behaviors.
Sphere—a knowledge unit visually represented as a cluster of data points/observations. Each knowledge unit is defined by a dynamic radius and a center.
Behavior—each number (e.g., n) of features for a particular metric.
Coverage—percentage of observations/data points located inside/captured by all the spheres.
   Further discussion of the INS model, and the above-defined terms, is provided below with reference to FIGS. 3-5.

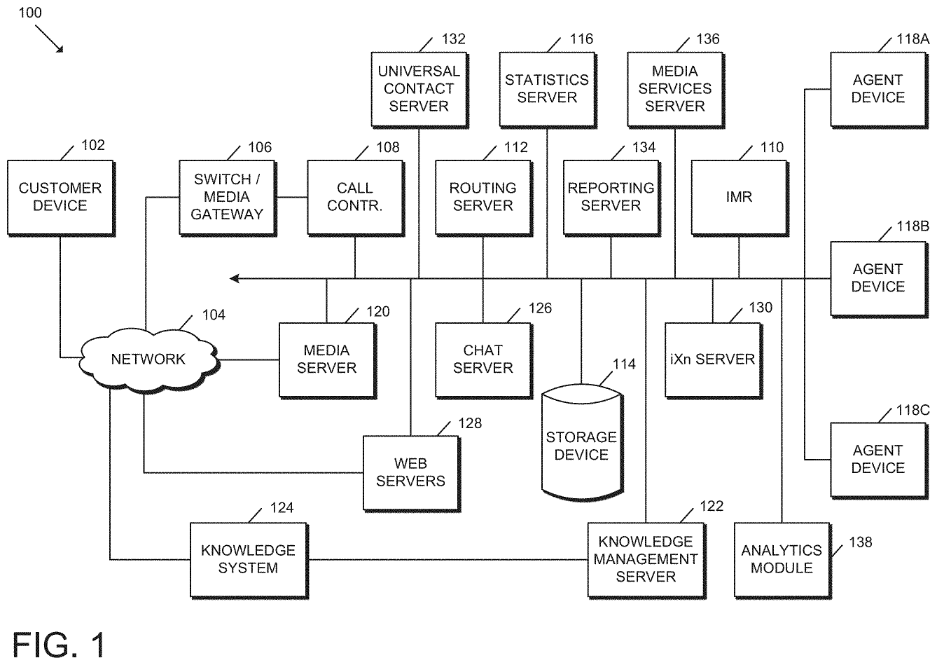

Referring now to FIG. 1, a simplified block diagram of at least one embodiment of a communications infrastructure and/or contact center system, which may be used in conjunction with one or more of the embodiments described herein, is shown. In the illustrative embodiment, the contact center system 100 is embodied as, or otherwise includes, a system configured to implement the INS model to detect anomalies in data provided by one or more customers. The contact center system 100 may be embodied as any system capable of providing contact center services (e.g., call center services, chat center services, SMS center services, etc.) to an end user and otherwise performing the functions described herein. The illustrative contact center system 100 includes a customer device 102, a network 104, a switch/media gateway 106, a call controller 108, an interactive media response (IMR) server 110, a routing server 112, a storage device 114, a statistics server 116, agent devices 118A, 118B, 118C, a media server 120, a knowledge management server 122, a knowledge system 124, a chat server 126, web servers 128, an interaction (iXn) server 130, a universal contact server 132, a reporting server 134, a media services server 136, and an analytics module 138. Although only one customer device 102, one network 104, one switch/media gateway 106, one call controller 108, one IMR server 110, one routing server 112, one storage device 114, one statistics server 116, one media server 120, one knowledge management server 122, one knowledge system 124, one chat server 126, one iXn server 130, one universal contact server 132, one reporting server 134, one media services server 136, and one analytics module 138 are shown in the illustrative embodiment of FIG. 1, the contact center system 100 may include multiple customer devices 102, networks 104, switch/media gateways 106, call controllers 108, IMR servers 110, routing servers 112, storage devices 114, statistics servers 116, media servers 120, knowledge management servers 122, knowledge systems 124, chat servers 126, iXn servers 130, universal contact servers 132, reporting servers 134, media services servers 136, and/or analytics modules 138 in other embodiments. Further, in some embodiments, one or more of the components described herein may be excluded from the system 100, one or more of the components described as being independent may form a portion of another component, and/or one or more of the component described as forming a portion of another component may be independent.

It should be understood that the term “contact center system” is used herein to refer to the system depicted in FIG. 1 and/or the components thereof, while the term “contact center” is used more generally to refer to contact center systems, customer service providers operating those systems, and/or the organizations or enterprises associated therewith. Thus, unless otherwise specifically limited, the term “contact center” refers generally to a contact center system (such as the contact center system 100), the associated customer service provider (such as a particular customer service provider providing customer services through the contact center system 100), as well as the organization or enterprise on behalf of which those customer services are being provided.

By way of background, customer service providers may offer many types of services through contact centers. Such contact centers may be staffed with employees or customer service agents (or simply “agents”), with the agents serving as an interface between a company, enterprise, government agency, or organization (hereinafter referred to interchangeably as an “organization” or “enterprise”) and persons, such as users, individuals, or customers (hereinafter referred to interchangeably as “individuals” or “customers”). For example, the agents at a contact center may assist customers in making purchasing decisions, receiving orders, or solving problems with products or services already received. Within a contact center, such interactions between contact center agents and outside entities or customers may be conducted over a variety of communication channels, such as, for example, via voice (e.g., telephone calls or voice over IP or VoIP calls), video (e.g., video conferencing), text (e.g., emails and text chat), screen sharing, co-browsing, and/or other communication channels.

Operationally, contact centers generally strive to provide quality services to customers while minimizing costs. For example, one way for a contact center to operate is to handle every customer interaction with a live agent. While this approach may score well in terms of the service quality, it likely would also be prohibitively expensive due to the high cost of agent labor. Because of this, most contact centers utilize some level of automated processes in place of live agents, such as, for example, interactive voice response (IVR) systems, interactive media response (IMR) systems, internet robots or “bots”, automated chat modules or “chatbots”, and/or other automated processed. In many cases, this has proven to be a successful strategy, as automated processes can be highly efficient in handling certain types of interactions and effective at decreasing the need for live agents. Such automation allows contact centers to target the use of human agents for the more difficult customer interactions, while the automated processes handle the more repetitive or routine tasks. Further, automated processes can be structured in a way that optimizes efficiency and promotes repeatability. Whereas a human or live agent may forget to ask certain questions or follow-up on particular details, such mistakes are typically avoided through the use of automated processes. While customer service providers are increasingly relying on automated processes to interact with customers, the use of such technologies by customers remains far less developed. Thus, while IVR systems, IMR systems, and/or bots are used to automate portions of the interaction on the contact center-side of an interaction, the actions on the customer-side remain for the customer to perform manually.

It should be appreciated that the contact center system 100 may be used by a customer service provider to provide various types of services to customers. For example, the contact center system 100 may be used to engage and manage interactions in which automated processes (or bots) or human agents communicate with customers. As should be understood, the contact center system 100 may be an in-house facility to a business or enterprise for performing the functions of sales and customer service relative to products and services available through the enterprise. In another embodiment, the contact center system 100 may be operated by a third-party service provider that contracts to provide services for another organization. Further, the contact center system 100 may be deployed on equipment dedicated to the enterprise or third-party service provider, and/or deployed in a remote computing environment such as, for example, a private or public cloud environment with infrastructure for supporting multiple contact centers for multiple enterprises. The contact center system 100 may include software applications or programs, which may be executed on premises or remotely or some combination thereof. It should further be appreciated that the various components of the contact center system 100 may be distributed across various geographic locations and not necessarily contained in a single location or computing environment.

It should further be understood that, unless otherwise specifically limited, any of the computing elements of the technologies described herein may be implemented in cloud-based or cloud computing environments. As used herein and further described below in reference to the computing device 200, “cloud computing”—or, simply, the “cloud”—is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. Cloud computing can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.). Often referred to as a “serverless architecture”, a cloud execution model generally includes a service provider dynamically managing an allocation and provisioning of remote servers for achieving a desired functionality.

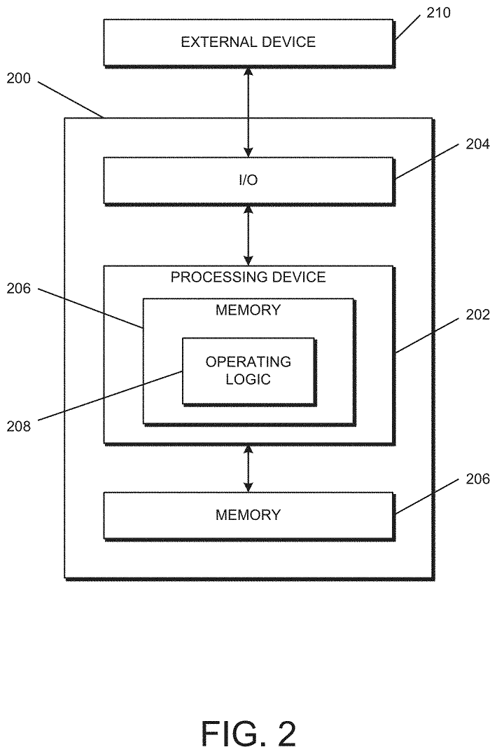

It should be understood that any of the computer-implemented components, modules, or servers described in relation to FIG. 1 may be implemented via one or more types of computing devices, such as, for example, the computing device 200 of FIG. 2. As will be seen, the contact center system 100 generally manages resources (e.g., personnel, computers, telecommunication equipment, etc.) to enable delivery of services via telephone, email, chat, or other communication mechanisms. Such services may vary depending on the type of contact center and, for example, may include customer service, help desk functionality, emergency response, telemarketing, order taking, and/or other characteristics.

Customers desiring to receive services from the contact center system 100 may initiate inbound communications (e.g., telephone calls, emails, chats, etc.) to the contact center system 100 via a customer device 102. While FIG. 1 shows one such customer device—i.e., customer devices 102—it should be understood that any number of customer devices 102 may be present. The customer devices 102, for example, may be a communication device, such as a telephone, smart phone, computer, tablet, or laptop. In accordance with functionality described herein, customers may generally use the customer devices 102 to initiate, manage, and conduct communications with the contact center system 100, such as telephone calls, emails, chats, text messages, web-browsing sessions, and other multi-media transactions.

Inbound and outbound communications from and to the customer devices 102 may traverse the network 104, with the nature of the network typically depending on the type of customer device being used and the form of communication. As an example, the network 104 may include a communication network of telephone, cellular, and/or data services. The network 104 may be a private or public switched telephone network (PSTN), local area network (LAN), private wide area network (WAN), and/or public WAN such as the Internet. Further, the network 104 may include a wireless carrier network including a code division multiple access (CDMA) network, global system for mobile communications (GSM) network, or any wireless network/technology conventional in the art, including but not limited to 3G, 4G, LTE, 5G, etc.

The switch/media gateway 106 may be coupled to the network 104 for receiving and transmitting telephone calls between customers and the contact center system 100. The switch/media gateway 106 may include a telephone or communication switch configured to function as a central switch for agent level routing within the center. The switch may be a hardware switching system or implemented via software. For example, the switch 106 may include an automatic call distributor, a private branch exchange (PBX), an IP-based software switch, and/or any other switch with specialized hardware and software configured to receive Internet-sourced interactions and/or telephone network-sourced interactions from a customer, and route those interactions to, for example, one of the agent devices 118. Thus, in general, the switch/media gateway 106 establishes a voice connection between the customer and the agent by establishing a connection between the customer device 102 and agent device 118.

As further shown, the switch/media gateway 106 may be coupled to the call controller 108 which, for example, serves as an adapter or interface between the switch and the other routing, monitoring, and communication-handling components of the contact center system 100. The call controller 108 may be configured to process PSTN calls, VoIP calls, and/or other types of calls. For example, the call controller 108 may include computer-telephone integration (CTI) software for interfacing with the switch/media gateway and other components. The call controller 108 may include a session initiation protocol (SIP) server for processing SIP calls. The call controller 108 may also extract data about an incoming interaction, such as the customer's telephone number, IP address, or email address, and then communicate these with other contact center components in processing the interaction.

The interactive media response (IMR) server 110 may be configured to enable self-help or virtual assistant functionality. Specifically, the IMR server 110 may be similar to an interactive voice response (IVR) server, except that the IMR server 110 is not restricted to voice and may also cover a variety of media channels. In an example illustrating voice, the IMR server 110 may be configured with an IMR script for querying customers on their needs. For example, a contact center for a bank may instruct customers via the IMR script to “press 1” if they wish to retrieve their account balance. Through continued interaction with the IMR server 110, customers may receive service without needing to speak with an agent. The IMR server 110 may also be configured to ascertain why a customer is contacting the contact center so that the communication may be routed to the appropriate resource. The IMR configuration may be performed through the use of a self-service and/or assisted service tool which comprises a web-based tool for developing IVR applications and routing applications running in the contact center environment (e.g. Genesys® Designer).

The routing server 112 may function to route incoming interactions. For example, once it is determined that an inbound communication should be handled by a human agent, functionality within the routing server 112 may select the most appropriate agent and route the communication thereto. This agent selection may be based on which available agent is best suited for handling the communication. More specifically, the selection of appropriate agent may be based on a routing strategy or algorithm that is implemented by the routing server 112. In doing this, the routing server 112 may query data that is relevant to the incoming interaction, for example, data relating to the particular customer, available agents, and the type of interaction, which, as described herein, may be stored in particular databases. Once the agent is selected, the routing server 112 may interact with the call controller 108 to route (i.e., connect) the incoming interaction to the corresponding agent device 118. As part of this connection, information about the customer may be provided to the selected agent via their agent device 118. This information is intended to enhance the service the agent is able to provide to the customer.

It should be appreciated that the contact center system 100 may include one or more mass storage devices—represented generally by the storage device 114—for storing data in one or more databases relevant to the functioning of the contact center. For example, the storage device 114 may store customer data that is maintained in a customer database. Such customer data may include, for example, customer profiles, contact information, service level agreement (SLA), and interaction history (e.g., details of previous interactions with a particular customer, including the nature of previous interactions, disposition data, wait time, handle time, and actions taken by the contact center to resolve customer issues). As another example, the storage device 114 may store agent data in an agent database. Agent data maintained by the contact center system 100 may include, for example, agent availability and agent profiles, schedules, skills, handle time, and/or other relevant data. As another example, the storage device 114 may store interaction data in an interaction database. Interaction data may include, for example, data relating to numerous past interactions between customers and contact centers. More generally, it should be understood that, unless otherwise specified, the storage device 114 may be configured to include databases and/or store data related to any of the types of information described herein, with those databases and/or data being accessible to the other modules or servers of the contact center system 100 in ways that facilitate the functionality described herein. For example, the servers or modules of the contact center system 100 may query such databases to retrieve data stored therein or transmit data thereto for storage. The storage device 114, for example, may take the form of any conventional storage medium and may be locally housed or operated from a remote location. As an example, the databases may be Cassandra database, NoSQL database, or a SQL database and managed by a database management system, such as, Oracle, IBM DB2, Microsoft SQL server, or Microsoft Access, PostgreSQL.

The statistics server 116 may be configured to record and aggregate data relating to the performance and operational aspects of the contact center system 100. Such information may be compiled by the statistics server 116 and made available to other servers and modules, such as the reporting server 134, which then may use the data to produce reports that are used to manage operational aspects of the contact center and execute automated actions in accordance with functionality described herein. Such data may relate to the state of contact center resources, e.g., average wait time, abandonment rate, agent occupancy, and others as functionality described herein would require.

The agent devices 118 of the contact center system 100 may be communication devices configured to interact with the various components and modules of the contact center system 100 in ways that facilitate functionality described herein. An agent device 118, for example, may include a telephone adapted for regular telephone calls or VoIP calls. An agent device 118 may further include a computing device configured to communicate with the servers of the contact center system 100, perform data processing associated with operations, and interface with customers via voice, chat, email, and other multimedia communication mechanisms according to functionality described herein. Although FIG. 1 shows three such agent devices 118—i.e., agent devices 118A, 118B and 118C—it should be understood that any number of agent devices 118 may be present in a particular embodiment.

The multimedia/social media server 120 may be configured to facilitate media interactions (other than voice) with the customer devices 102 and/or the servers 128. Such media interactions may be related, for example, to email, voice mail, chat, video, text-messaging, web, social media, co-browsing, etc. The multi-media/social media server 120 may take the form of any IP router conventional in the art with specialized hardware and software for receiving, processing, and forwarding multi-media events and communications.

The knowledge management server 122 may be configured to facilitate interactions between customers and the knowledge system 124. In general, the knowledge system 124 may be a computer system capable of receiving questions or queries and providing answers in response. The knowledge system 124 may be included as part of the contact center system 100 or operated remotely by a third party. The knowledge system 124 may include an artificially intelligent computer system capable of answering questions posed in natural language by retrieving information from information sources such as encyclopedias, dictionaries, newswire articles, literary works, or other documents submitted to the knowledge system 124 as reference materials. As an example, the knowledge system 124 may be embodied as IBM Watson or a similar system.

The chat server 126 may be configured to conduct, orchestrate, and manage electronic chat communications with customers. In general, the chat server 126 is configured to implement and maintain chat conversations and generate chat transcripts. Such chat communications may be conducted by the chat server 126 in such a way that a customer communicates with automated chatbots, human agents, or both. In exemplary embodiments, the chat server 126 may perform as a chat orchestration server that dispatches chat conversations among the chatbots and available human agents. In such cases, the processing logic of the chat server 126 may be rules driven so to leverage an intelligent workload distribution among available chat resources. The chat server 126 further may implement, manage, and facilitate user interfaces (UIs) associated with the chat feature, including those UIs generated at either the customer device 102 or the agent device 118. The chat server 126 may be configured to transfer chats within a single chat session with a particular customer between automated and human sources such that, for example, a chat session transfers from a chatbot to a human agent or from a human agent to a chatbot. The chat server 126 may also be coupled to the knowledge management server 122 and the knowledge systems 124 for receiving suggestions and answers to queries posed by customers during a chat so that, for example, links to relevant articles can be provided.

The web servers 128 may be included to provide site hosts for a variety of social interaction sites to which customers subscribe, such as Facebook, Twitter, Instagram, etc. Though depicted as part of the contact center system 100, it should be understood that the web servers 128 may be provided by third parties and/or maintained remotely. The web servers 128 may also provide webpages for the enterprise or organization being supported by the contact center system 100. For example, customers may browse the webpages and receive information about the products and services of a particular enterprise. Within such enterprise webpages, mechanisms may be provided for initiating an interaction with the contact center system 100, for example, via web chat, voice, or email. An example of such a mechanism is a widget, which can be deployed on the webpages or websites hosted on the web servers 128. As used herein, a widget refers to a user interface component that performs a particular function. In some implementations, a widget may include a graphical user interface control that can be overlaid on a webpage displayed to a customer via the Internet. The widget may show information, such as in a window or text box, or include buttons or other controls that allow the customer to access certain functionalities, such as sharing or opening a file or initiating a communication. In some implementations, a widget includes a user interface component having a portable portion of code that can be installed and executed within a separate webpage without compilation. Some widgets can include corresponding or additional user interfaces and be configured to access a variety of local resources (e.g., a calendar or contact information on the customer device) or remote resources via network (e.g., instant messaging, electronic mail, or social networking updates).

The interaction (iXn) server 130 may be configured to manage deferrable activities of the contact center and the routing thereof to human agents for completion. As used herein, deferrable activities may include back-office work that can be performed off-line, e.g., responding to emails, attending training, and other activities that do not entail real-time communication with a customer. As an example, the interaction (iXn) server 130 may be configured to interact with the routing server 112 for selecting an appropriate agent to handle each of the deferrable activities. Once assigned to a particular agent, the deferrable activity is pushed to that agent so that it appears on the agent device 118 of the selected agent. The deferrable activity may appear in a workbin as a task for the selected agent to complete. The functionality of the workbin may be implemented via any conventional data structure, such as, for example, a linked list, array, and/or other suitable data structure. Each of the agent devices 118 may include a workbin. As an example, a workbin may be maintained in the buffer memory of the corresponding agent device 118.

The universal contact server (UCS) 132 may be configured to retrieve information stored in the customer database and/or transmit information thereto for storage therein. For example, the UCS 132 may be utilized as part of the chat feature to facilitate maintaining a history on how chats with a particular customer were handled, which then may be used as a reference for how future chats should be handled. More generally, the UCS 132 may be configured to facilitate maintaining a history of customer preferences, such as preferred media channels and best times to contact. To do this, the UCS 132 may be configured to identify data pertinent to the interaction history for each customer such as, for example, data related to comments from agents, customer communication history, and the like. Each of these data types then may be stored in the customer database or on other modules and retrieved as functionality described herein requires.

The reporting server 134 may be configured to generate reports from data compiled and aggregated by the statistics server 116 or other sources. Such reports may include near real-time reports or historical reports and concern the state of contact center resources and performance characteristics, such as, for example, average wait time, abandonment rate, and/or agent occupancy. The reports may be generated automatically or in response to specific requests from a requestor (e.g., agent, administrator, contact center application, etc.). The reports then may be used toward managing the contact center operations in accordance with functionality described herein.

The media services server 136 may be configured to provide audio and/or video services to support contact center features. In accordance with functionality described herein, such features may include prompts for an IVR or IMR system (e.g., playback of audio files), hold music, voicemails/single party recordings, multi-party recordings (e.g., of audio and/or video calls), speech recognition, dual tone multi frequency (DTMF) recognition, faxes, audio and video transcoding, secure real-time transport protocol (SRTP), audio conferencing, video conferencing, coaching (e.g., support for a coach to listen in on an interaction between a customer and an agent and for the coach to provide comments to the agent without the customer hearing the comments), call analysis, keyword spotting, and/or other relevant features.

The analytics module 138 may be configured to provide systems and methods for performing analytics on data received from a plurality of different data sources as functionality described herein may require. In accordance with example embodiments, the analytics module 138 also may generate, update, train, and modify predictors or models based on collected data, such as, for example, customer data, agent data, and interaction data. The models may include behavior models of customers or agents. The behavior models may be used to predict behaviors of, for example, customers or agents, in a variety of situations, thereby allowing embodiments of the technologies described herein to tailor interactions based on such predictions or to allocate resources in preparation for predicted characteristics of future interactions, thereby improving overall contact center performance and the customer experience. It will be appreciated that, while the analytics module is described as being part of a contact center, such behavior models also may be implemented on customer systems (or, as also used herein, on the “customer-side” of the interaction) and used for the benefit of customers.

According to exemplary embodiments, the analytics module 138 may have access to the data stored in the storage device 114, including the customer database and agent database. The analytics module 138 also may have access to the interaction database, which stores data related to interactions and interaction content (e.g., transcripts of the interactions and events detected therein), interaction metadata (e.g., customer identifier, agent identifier, medium of interaction, length of interaction, interaction start and end time, department, tagged categories), and the application setting (e.g., the interaction path through the contact center). Further, the analytic module 138 may be configured to retrieve data stored within the storage device 114 for use in developing and training algorithms and models, for example, by applying machine learning techniques.

One or more of the included models may be configured to predict customer or agent behavior and/or aspects related to contact center operation and performance. Further, one or more of the models may be used in natural language processing and, for example, include intent recognition and the like. The models may be developed based upon known first principle equations describing a system; data, resulting in an empirical model; or a combination of known first principle equations and data. In developing a model for use with present embodiments, because first principles equations are often not available or easily derived, it may be generally preferred to build an empirical model based upon collected and stored data. To properly capture the relationship between the manipulated/disturbance variables and the controlled variables of complex systems, in some embodiments, it may be preferable that the models are nonlinear. This is because nonlinear models can represent curved rather than straight-line relationships between manipulated/disturbance variables and controlled variables, which are common to complex systems such as those discussed herein. Given the foregoing requirements, a machine learning or neural network-based approach may be a preferred embodiment for implementing the models. Neural networks, for example, may be developed based upon empirical data using advanced regression algorithms.

The analytics module 138 may further include an optimizer. As will be appreciated, an optimizer may be used to minimize a “cost function” subject to a set of constraints, where the cost function is a mathematical representation of desired objectives or system operation. Because the models may be non-linear, the optimizer may be a nonlinear programming optimizer. It is contemplated, however, that the technologies described herein may be implemented by using, individually or in combination, a variety of different types of optimization approaches, including, but not limited to, linear programming, quadratic programming, mixed integer non-linear programming, stochastic programming, global non-linear programming, genetic algorithms, particle/swarm techniques, and the like.

According to some embodiments, the models and the optimizer may together be used within an optimization system. For example, the analytics module 138 may utilize the optimization system as part of an optimization process by which aspects of contact center performance and operation are optimized or, at least, enhanced. This, for example, may include features related to the customer experience, agent experience, interaction routing, natural language processing, intent recognition, or other functionality related to automated processes.

The various components, modules, and/or servers of FIG. 1 (as well as the other figures included herein) may each include one or more processors executing computer program instructions and interacting with other system components for performing the various functionalities described herein. Such computer program instructions may be stored in a memory implemented using a standard memory device, such as, for example, a random-access memory (RAM), or stored in other non-transitory computer readable media such as, for example, a CD-ROM, flash drive, etc. Although the functionality of each of the servers is described as being provided by the particular server, a person of skill in the art should recognize that the functionality of various servers may be combined or integrated into a single server, or the functionality of a particular server may be distributed across one or more other servers without departing from the scope of the technologies described herein. Further, the terms “interaction” and “communication” are used interchangeably, and generally refer to any real-time and non-real-time interaction that uses any communication channel including, without limitation, telephone calls (PSTN or VoIP calls), emails, vmails, video, chat, screen-sharing, text messages, social media messages, WebRTC calls, etc. Access to and control of the components of the contact center system 100 may be affected through user interfaces (UIs) which may be generated on the customer devices 102 and/or the agent devices 118. As already noted, the contact center system 100 may operate as a hybrid system in which some or all components are hosted remotely, such as in a cloud-based or cloud computing environment. It should be appreciated that each of the devices of the contact center system 100 may be embodied as, include, or form a portion of one or more computing devices similar to the computing device 200 described below in reference to FIG. 2.

Referring now to FIG. 2, a simplified block diagram of at least one embodiment of a computing device 200 is shown. In the illustrative embodiment, the computing device 200 is embodied as, or otherwise includes, a device configured to implement the INS model to detect anomalies in data provided by one or more customers. The illustrative computing device 200 depicts at least one embodiment of each of the computing devices, systems, servicers, controllers, switches, gateways, engines, modules, and/or computing components described herein (e.g., which collectively may be referred to interchangeably as computing devices, servers, or modules for brevity of the description). For example, the various computing devices may be a process or thread running on one or more processors of one or more computing devices 200, which may be executing computer program instructions and interacting with other system modules in order to perform the various functionalities described herein. Unless otherwise specifically limited, the functionality described in relation to a plurality of computing devices may be integrated into a single computing device, or the various functionalities described in relation to a single computing device may be distributed across several computing devices. Further, in relation to the computing systems described herein—such as the contact center system 100 of FIG. 1—the various servers and computer devices thereof may be located on local computing devices 200 (e.g., on-site at the same physical location as the agents of the contact center), remote computing devices 200 (e.g., off-site or in a cloud-based or cloud computing environment, for example, in a remote data center connected via a network), or some combination thereof. In some embodiments, functionality provided by servers located on computing devices off-site may be accessed and provided over a virtual private network (VPN), as if such servers were on-site, or the functionality may be provided using a software as a service (SaaS) accessed over the Internet using various protocols, such as by exchanging data via extensible markup language (XML), JSON, and/or the functionality may be otherwise accessed/leveraged.

In some embodiments, the computing device 200 may be embodied as a server, desktop computer, laptop computer, tablet computer, notebook, netbook, Ultrabook™, cellular phone, mobile computing device, smartphone, wearable computing device, personal digital assistant, Internet of Things (IoT) device, processing system, wireless access point, router, gateway, and/or any other computing, processing, and/or communication device capable of performing the functions described herein.

The computing device 200 includes a processing device 202 that executes algorithms and/or processes data in accordance with operating logic 208, an input/output device 204 that enables communication between the computing device 200 and one or more external devices 210, and memory 206 which stores, for example, data received from the external device 210 via the input/output device 204.

The input/output device 204 allows the computing device 200 to communicate with the external device 210. For example, the input/output device 204 may include a transceiver, a network adapter, a network card, an interface, one or more communication ports (e.g., a USB port, serial port, parallel port, an analog port, a digital port, VGA, DVI, HDMI, FireWire, CAT 5, or any other type of communication port or interface), and/or other communication circuitry. Communication circuitry of the computing device 200 may be configured to use any one or more communication technologies (e.g., wireless or wired communications) and associated protocols (e.g., Ethernet, Bluetooth®, Wi-Fi®, WiMAX, etc.) to effect such communication depending on the particular computing device 200. The input/output device 204 may include hardware, software, and/or firmware suitable for performing the techniques described herein.

The external device 210 may be any type of device that allows data to be inputted or outputted from the computing device 200. For example, in various embodiments, the external device 210 may be embodied as one or more of the devices/systems described herein, and/or a portion thereof. Further, in some embodiments, the external device 210 may be embodied as another computing device, switch, diagnostic tool, controller, printer, display, alarm, peripheral device (e.g., keyboard, mouse, touch screen display, etc.), and/or any other computing, processing, and/or communication device capable of performing the functions described herein. Furthermore, in some embodiments, it should be appreciated that the external device 210 may be integrated into the computing device 200.

The processing device 202 may be embodied as any type of processor(s) capable of performing the functions described herein. In particular, the processing device 202 may be embodied as one or more single or multi-core processors, microcontrollers, or other processor or processing/controlling circuits. For example, in some embodiments, the processing device 202 may include or be embodied as an arithmetic logic unit (ALU), central processing unit (CPU), digital signal processor (DSP), graphics processing unit (GPU), field-programmable gate array (FPGA), application-specific integrated circuit (ASIC), and/or another suitable processor(s). The processing device 202 may be a programmable type, a dedicated hardwired state machine, or a combination thereof. Processing devices 202 with multiple processing units may utilize distributed, pipelined, and/or parallel processing in various embodiments. Further, the processing device 202 may be dedicated to performance of just the operations described herein, or may be utilized in one or more additional applications. In the illustrative embodiment, the processing device 202 is programmable and executes algorithms and/or processes data in accordance with operating logic 208 as defined by programming instructions (such as software or firmware) stored in memory 206. Additionally or alternatively, the operating logic 208 for processing device 202 may be at least partially defined by hardwired logic or other hardware. Further, the processing device 202 may include one or more components of any type suitable to process the signals received from input/output device 204 or from other components or devices and to provide desired output signals. Such components may include digital circuitry, analog circuitry, or a combination thereof.

The memory 206 may be of one or more types of non-transitory computer-readable media, such as a solid-state memory, electromagnetic memory, optical memory, or a combination thereof. Furthermore, the memory 206 may be volatile and/or nonvolatile and, in some embodiments, some or all of the memory 206 may be of a portable type, such as a disk, tape, memory stick, cartridge, and/or other suitable portable memory. In operation, the memory 206 may store various data and software used during operation of the computing device 200 such as operating systems, applications, programs, libraries, and drivers. It should be appreciated that the memory 206 may store data that is manipulated by the operating logic 208 of processing device 202, such as, for example, data representative of signals received from and/or sent to the input/output device 204 in addition to or in lieu of storing programming instructions defining operating logic 208. As shown in FIG. 2, the memory 206 may be included with the processing device 202 and/or coupled to the processing device 202 depending on the particular embodiment. For example, in some embodiments, the processing device 202, the memory 206, and/or other components of the computing device 200 may form a portion of a system-on-a-chip (SoC) and be incorporated on a single integrated circuit chip.

In some embodiments, various components of the computing device 200 (e.g., the processing device 202 and the memory 206) may be communicatively coupled via an input/output subsystem, which may be embodied as circuitry and/or components to facilitate input/output operations with the processing device 202, the memory 206, and other components of the computing device 200. For example, the input/output subsystem may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations.

The computing device 200 may include other or additional components, such as those commonly found in a typical computing device (e.g., various input/output devices and/or other components), in other embodiments. It should be further appreciated that one or more of the components of the computing device 200 described herein may be distributed across multiple computing devices. In other words, the techniques described herein may be employed by a computing system that includes one or more computing devices. Additionally, although only a single processing device 202, I/O device 204, and memory 206 are illustratively shown in FIG. 2, it should be appreciated that a particular computing device 200 may include multiple processing devices 202, I/O devices 204, and/or memories 206 in other embodiments. Further, in some embodiments, more than one external device 210 may be in communication with the computing device 200.

The computing device 200 may be one of a plurality of devices connected by a network or connected to other systems/resources via a network. The network may be embodied as any one or more types of communication networks that are capable of facilitating communication between the various devices communicatively connected via the network. As such, the network may include one or more networks, routers, switches, access points, hubs, computers, client devices, endpoints, nodes, and/or other intervening network devices. For example, the network may be embodied as or otherwise include one or more cellular networks, telephone networks, local or wide area networks, publicly available global networks (e.g., the Internet), ad hoc networks, short-range communication links, or a combination thereof. In some embodiments, the network may include a circuit-switched voice or data network, a packet-switched voice or data network, and/or any other network able to carry voice and/or data. In particular, in some embodiments, the network may include Internet Protocol (IP)-based and/or asynchronous transfer mode (ATM)-based networks. In some embodiments, the network may handle voice traffic (e.g., via a Voice over IP (VOIP) network), web traffic, and/or other network traffic depending on the particular embodiment and/or devices of the system in communication with one another. In various embodiments, the network may include analog or digital wired and wireless networks (e.g., IEEE 802.11 networks, Public Switched Telephone Network (PSTN), Integrated Services Digital Network (ISDN), and Digital Subscriber Line (xDSL)), Third Generation (3G) mobile telecommunications networks, Fourth Generation (4G) mobile telecommunications networks, Fifth Generation (5G) mobile telecommunications networks, a wired Ethernet network, a private network (e.g., such as an intranet), radio, television, cable, satellite, and/or any other delivery or tunneling mechanism for carrying data, or any appropriate combination of such networks. It should be appreciated that the various devices/systems may communicate with one another via different networks depending on the source and/or destination devices/systems.

It should be appreciated that the computing device 200 may communicate with other computing devices 200 via any type of gateway or tunneling protocol such as secure socket layer or transport layer security. The network interface may include a built-in network adapter, such as a network interface card, suitable for interfacing the computing device to any type of network capable of performing the operations described herein. Further, the network environment may be a virtual network environment where the various network components are virtualized. For example, the various machines may be virtual machines implemented as a software-based computer running on a physical machine. The virtual machines may share the same operating system, or, in other embodiments, different operating system may be run on each virtual machine instance. For example, a “hypervisor” type of virtualizing is used where multiple virtual machines run on the same host physical machine, each acting as if it has its own dedicated box. Other types of virtualization may be employed in other embodiments, such as, for example, the network (e.g., via software defined networking) or functions (e.g., via network functions virtualization).

Accordingly, one or more of the computing devices 200 described herein may be embodied as, or form a portion of, one or more cloud-based systems. In cloud-based embodiments, the cloud-based system may be embodied as a server-ambiguous computing solution, for example, that executes a plurality of instructions on-demand, contains logic to execute instructions only when prompted by a particular activity/trigger, and does not consume computing resources when not in use. That is, system may be embodied as a virtual computing environment residing “on” a computing system (e.g., a distributed network of devices) in which various virtual functions (e.g., Lambda functions, Azure functions, Google cloud functions, and/or other suitable virtual functions) may be executed corresponding with the functions of the system described herein. For example, when an event occurs (e.g., data is transferred to the system for handling), the virtual computing environment may be communicated with (e.g., via a request to an API of the virtual computing environment), whereby the API may route the request to the correct virtual function (e.g., a particular server-ambiguous computing resource) based on a set of rules. As such, when a request for the transmission of data is made by a user (e.g., via an appropriate user interface to the system), the appropriate virtual function(s) may be executed to perform the actions before eliminating the instance of the virtual function(s).

Referring now to FIG. 3, in use, a system or a device may execute a method 300 of detecting anomalies in data provided by one or more customers. It should be appreciated that, in some embodiments, the system may be embodied as a contact center system (e.g., the contact center system 100 of FIG. 1) and/or a computing device (e.g., the computing device 200 of FIG. 2) or a system/device thereof. Furthermore, in some embodiments, the system may be embodied as, or otherwise include, a suite of tools to assist with the operational monitoring, management, and troubleshooting of various platforms. In one example, the system may be embodied as, or otherwise include, the suite of tools provided by Genesys Workbench (WB) 9.2, or any subsequent release(s) thereof. In particular, the system may incorporate various features of the Workbench Anomaly Detection (AD) feature, for example. Finally, it should be appreciated that the particular blocks of the method 300 are illustrated by way of example, and such blocks may be combined or divided, added or removed, and/or reordered in whole or in part depending on the particular embodiment, unless stated to the contrary.

The illustrative method 300 begins with block 312 in which the system receives metric data. In some embodiments, the metric data may be provided from a source external to, and/or remote from, the system, and the system may be communicatively coupled to the source to receive the metric data from the source. In any case, in the illustrative embodiment, the metric data is indicative of time-series based observations for a particular customer metric, and selection and/or specification of the metric may be based on, and/or tailored to, the unique needs of the particular customer. Receipt of the metric data in block 312 by the system may include, or otherwise be associated with, ingestion of the metric data from the source (e.g., CPU, RAM, Disk, Network).

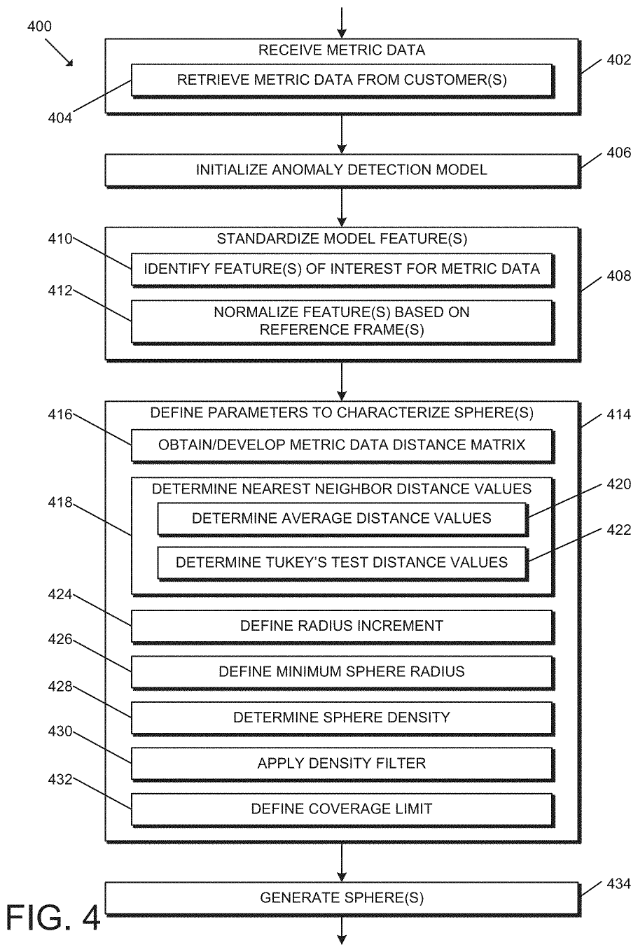

In block 314 of the illustrative method 300, the system defines, based on the metric data, parameters to characterize one or more spheres. Further detail regarding the definition of those parameters is described below with reference to FIG. 4 (i.e., in block 414). As evident from the foregoing discussion, each of the one or more spheres is configured to capture a number of time-series based observations from the metric data for a particular customer metric such that the observations are located inside the sphere.

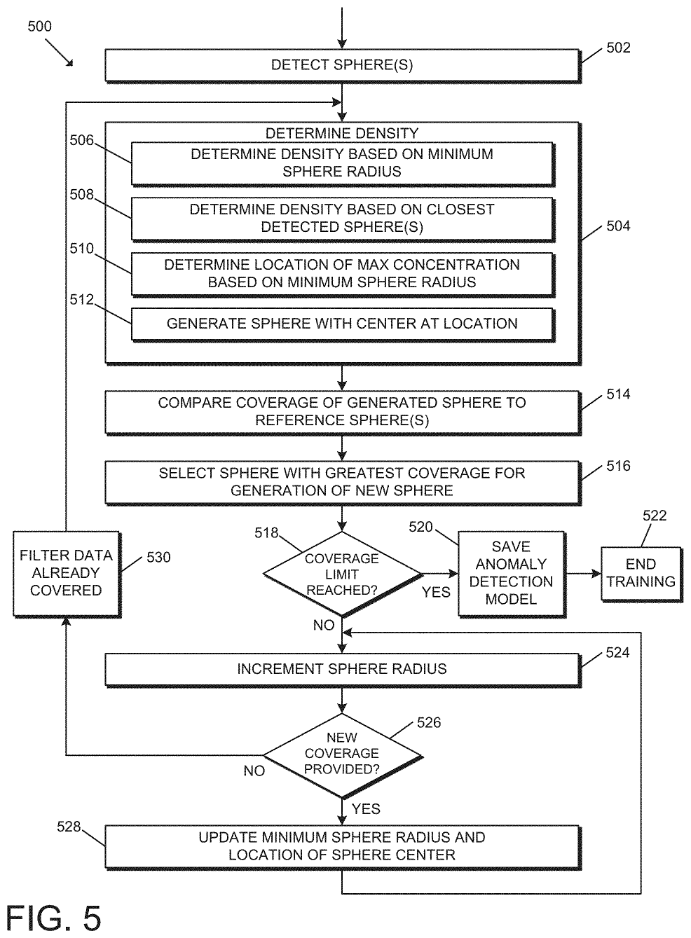

In block 316 of the illustrative method 300, the system generates, based on the parameters defined in block 314, one or more spheres. Further detail regarding the generation of spheres is described below with reference to FIG. 5. In the illustrative embodiment, to perform block 316, the system performs blocks 318 and 320. In block 318, the system determines coverage of the metric data within the one or more spheres. In block 320, the system dynamically generates multiple spheres having radii that vary based on the time-series based observations from the metric data for the particular customer metric. In some embodiments, the blocks 318 and 320 may be combined in a single block. In one example, determination of coverage in block 318 may be combined with dynamic generation of the spheres in block 320.

In block 322 of the illustrative method 300, the system saves the model parameters (e.g., parameters associated with sphere generation in block 316). In some embodiments, performance of block 322 may represent, or otherwise be associated with, complete creation of the INS model.

In block 324 of the illustrative method 300, the system detects one or more anomalies in the metric data based on the spheres generated in block 316 and/or the model parameters saved in block 322. In some embodiments, performance of block 324 may represent, or otherwise be associated with, an anomaly detection activity performed subsequent to creation of the INS model.

Although the blocks 312-324 are described in a relatively serial manner, it should be appreciated that various blocks of the method 300 may be performed in parallel in some embodiments.

Referring now to FIG. 4, in use, a system or a device may execute a method 400 of detecting anomalies in data provided by one or more customers. The method 400 may be similar to the method 300, and some blocks of the method 400 may provide further details regarding corresponding blocks of the method 300, as suggested above. It should be appreciated that, in some embodiments, the system may be embodied as a contact center system (e.g., the contact center system 100 of FIG. 1) and/or a computing device (e.g., the computing device 200 of FIG. 2) or a system/device thereof. Finally, it should be appreciated that the particular blocks of the method 400 are illustrated by way of example, and such blocks may be combined or divided, added or removed, and/or reordered in whole or in part depending on the particular embodiment, unless stated to the contrary.

The illustrative method 400 begins with block 402 in which the system receives metric data. It should be appreciated that block 402 corresponds to block 302 of the method 300, at least in some embodiments. In the illustrative embodiment, to perform block 402, the system performs block 404. In block 404, the system retrieves or ingests metric data from a source (e.g., a customer platform). In some embodiments, however, it should be appreciated that block 404 may be omitted.

In block 406 of the illustrative method 400, the system initializes the anomaly detection model (the INS model). In some embodiments, block 406 may be embodied as, or otherwise include, an input block to the INS model in which the metric data received in block 402 is fed into the INS model. Additionally, in some embodiments, block 406 may be incorporated into block 402.

In block 408 of the illustrative method 400, the system standardizes one or more features of the INS model. To do so, in the illustrative embodiment, the system performs blocks 410 and 412. In block 410, the system identifies one or more feature(s) of interest for the metric data received in block 402. Those feature(s) may include mathematical parameters for analyzing the metric data (e.g., statistical values, derivatives, weighted averages, etc.), for determining a particular distribution of the metric data, and/or for identifying one or more outliers contained the metric data, at least in some embodiments. In block 412, the system normalizes the feature(s) identified in block 410 based on one or more reference frames. In some embodiments, in block 412, the system establishes one or more reference frames for evaluating the features identified in block 410.

In block 414 of the illustrative method 400, the system defines, based on the metric data, parameters to characterize one or more spheres. It should be appreciated that block 414 corresponds to block 304 of method 300, at least in some embodiments. Furthermore, it should be appreciated that in at least some embodiments, performance of block 414 by the system serves as an activity preliminary to subsequent generation of one or more spheres In the illustrative embodiment, to perform block 414, the system performs blocks 416, 418, 424, 426, 428, 430, 432. Each of those blocks is discussed below.

In block 416 of the illustrative method 400, the system obtains or develops a distance matrix for the metric data received in block 402. In some embodiments, block 416 may be incorporated into block 410. In any case, the distance matrix obtained in block 416 allows the system to determine distances between observations/data points contained in the metric data.

In block 418 of the illustrative method 400, based on the distance matrix obtained in block 416, the system determines nearest neighbor distance values for each observation/data point in the metric data. In the illustrative embodiment, to perform block 418, the system performs blocks 420 and 422. In block 420, the system determines an average of the nearest neighbor distances for all the observations/data points in the metric data. In block 422, the system determines a maximum limit for the nearest neighbor distance values according to Tukey's test. In some embodiments, the system may perform blocks 420 and 422 in parallel with one another.

In block 424 of the illustrative method 400, the system defines a radius increment for generation of one or more spheres. As evident from the discussion that follows, in combination with the minimum sphere radius discussed below, the radius increment may be used to generate one or more new spheres subsequent to generation of a first/initial sphere, at least in some embodiments. Furthermore, due at least in part to variation of the radius increment and the minimum sphere radius over the course of performing the method 400, the one or more new spheres generated with the radius increment may have varying radii. In some embodiments, definition of the radius increment in block 424 is based on the average determined by the system in block 420.

In block 426 of the illustrative method 400, the system defines a minimum sphere radius for the generation of at least one sphere. The minimum sphere radius may be used to generate a first/initial sphere, at least in some embodiments. In some embodiments, definition of the minimum sphere radius in block 426 is based on the maximum limit determined by the system in block 422. Additionally, in some embodiments, the system may perform blocks 424 and 426 in parallel with one another.

In block 428 of the illustrative method 400, the system determines a density for the generation of at least one sphere. In some embodiments, the density corresponds to, or is otherwise embodied as, a number of observations/data points of the metric data that would fall inside, and be captured by, the first/initial sphere. The density of the sphere may be determined by, or be embodied as, the concentration of observations/data points in a particular region, at least in some embodiments. Additionally, in some embodiments, determination of the sphere density in block 428 is based on the distance matrix obtained by the system in block 416 and the minimum sphere radius defined by the system in block 426.

In block 430 of the illustrative method 400, the system applies a density filter to the sphere density determination made in block 428. In some embodiments, the density filter applied by the system in block 430 filters out outliers or abnormal/unusual observations from the metric data so that the outliers or abnormal observations do not affect the definition of the coverage limit described below.

In block 432 of the illustrative method 400, the system defines a coverage limit indicative of a maximum number of observations/data points to be covered by the spheres. In the illustrative embodiment, the coverage limit defined by the system in block 432 is based at least partially on the filtered metric data from block 430.

In block 434 of the illustrative method 400, the system generates one or more spheres based on the parameters defined in block 414. It should be appreciated that block 434 corresponds to block 306 of method 300, at least in some embodiments.

Although the blocks 402-434 are described in a relatively serial manner, it should be appreciated that various blocks of the method 400 may be performed in parallel in some embodiments.

Referring now to FIG. 5, in use, to perform block 434 of method 400, a system or a device may execute a method 500. The method 500 may be similar to block 306 of the method 300, at least in some embodiments. It should be appreciated that, in some embodiments, the system may be embodied as a contact center system (e.g., the contact center system 100 of FIG. 1) and/or a computing device (e.g., the computing device 200 of FIG. 2) or a system/device thereof. Finally, it should be appreciated that the particular blocks of the method 500 are illustrated by way of example, and such blocks may be combined or divided, added or removed, and/or reordered in whole or in part depending on the particular embodiment, unless stated to the contrary.

The illustrative method 500 begins with block 502 in which the system detects one or more spheres that have already been generated. It should be appreciated that in some cases (e.g., during the generation of a first/initial sphere), no sphere(s) may be detected in block 502. Therefore, in those cases, block 502 may be optionally omitted from the method.

In block 504 of the illustrative method 500, the system determines a density for the generation of at least one sphere. In some embodiments, the density corresponds to, or is otherwise embodied as, a number of observations/data points of the metric data that would fall inside, and be captured by, the first/initial sphere. In other embodiments, the density corresponds to, or is otherwise embodied as, a number of observations/data points of the metric data that fall inside, and are captured by, the first/initial sphere and one or more spheres closest to the first/initial sphere. In the illustrative embodiment, to perform block 504, the system performs blocks 506, 508, 510, and 512.

In block 506 of the illustrative method 500, the system determines the density based on the minimum sphere radius defined in block 426 of method 400. In block 508 of the illustrative method 500, the system determines the density based on the closest detected sphere(s) (e.g., the sphere(s) detected in block 502). It should be appreciated that in some cases (e.g., during the generation of a first/initial sphere), no closest spheres may be detected, and the system may not perform block 508. Furthermore, it should be appreciated that in other cases (e.g., when one or more closest spheres have been generated subsequent to generation of the first/initial sphere), determination of the density in block 504 may be based on both the minimum sphere radius defined in block 426 of method 400 and the closest detected sphere(s) (e.g., from block 502). Thus, in those cases, blocks 506 and 508 may be combined into a single block.

In block 510 of the illustrative method 500, the system determines a location corresponding to a maximum concentration of metric data based at least partially on the minimum sphere radius defined in block 426. In some cases, the location determined by the system in block 510 may also be based on the closest detected sphere(s). In block 512, the system generates at least one sphere such that a center of the sphere is positioned at the location determined in block 510. The at least one sphere generated in block 512 by the system may correspond to the first/initial sphere, at least in some cases. In other cases, the at least one sphere generated in block 512 by the system may correspond to a sphere generated subsequent to the first/initial sphere. In those cases, the system may (i) determine (i.e., in block 510) another location corresponding to the maximum concentration of metric data based on the minimum sphere radius defined in block 426 and a distance between the first/initial sphere and at least one nearest neighboring sphere and (ii) generate (i.e., in block 512) at least one new sphere such that a center of the at least one new sphere is positioned at the another location.

In block 514 of the illustrative method 500, the system compares coverage of the metric data provided by the new or latest generated sphere to coverage of the metric data provided by one or more reference sphere(s). In one example, the reference sphere(s) include the first/initial sphere. In another example, the reference sphere(s) include the first/initial sphere and at least one nearest neighboring sphere generated subsequent to the first sphere. Of course, in the event the sphere generated by the system in block 512 corresponds to the first/initial sphere, performance of block 514 may be omitted, at least in some embodiments.

In block 516 of the illustrative method 500, the system selects whichever sphere (i.e., of the spheres compared in block 514) provides the greatest coverage of the metric data for generation of another new sphere. It should be appreciated that in the event the sphere generated by the system in block 512 corresponds to the first/initial sphere, performance of block 516 may be omitted, at least in some embodiments.

In block 518 of the illustrative method 500, the system determines whether the coverage limit defined in block 432 of the method 400 has been reached.

In block 520 of the illustrative method 500, in response to a determination in block 518 that the coverage limit has been reached, the system saves the anomaly detection model (i.e., the INS model).

In block 522 of the illustrative method 500, the system ends training of the model based on the metric data.

In block 524 of the illustrative method 500, in response to a determination in block 518 that the coverage limit has not been reached, the system increments the radius for generation of at least one new sphere based on the radius increment defined in block 424 of method 400.

In block 526 of the illustrative method 500, the system determines whether the at least one new sphere (for which the radius is incremented in block 524) provides coverage of the metric data not previously provided.

In block 528 of the illustrative method 500, in response to a determination in block 526 that the at least one new sphere provides coverage of the metric data not previously provided, the system updates the minimum sphere radius (e.g., the minimum sphere radius defined in block 426 of method 400) and the location (e.g., the location discussed above with reference to block 512) corresponding to the center for the generation of the next sphere.

In block 530 of the illustrative method 500, in response to a determination in block 526 that the at least one new sphere does not provide coverage of the metric data not previously provided, the system filters out the metric data associated with the at least one new sphere.

Although the blocks 502-530 are described in a relatively serial manner, it should be appreciated that various blocks of the method 500 may be performed in parallel in some embodiments.

A number of unique features and/or advantages may be associated with execution and implementation of the illustrative INS model by the system. In one aspect, because the model may be trained irrespective of the particular customer metric, the model offers automatic parameter tuning across a wide range of various metrics. In another aspect, as the model does not rely on a predetermined number of spheres to be generated for a particular customer metric, spheres may be generated according to each iteration of the model, which may provide greater accuracy and/or precision, at least in some cases. In yet another aspect, since the locations of spheres generated by the model are determined based on high density/concentrations regions, the model avoids limitations associated with locating spheres according to a random probability distribution. In yet another aspect still, by filtering/removing metric data points already covered by previous iterations, the computational complexity of the model is reduced compared to other configurations. In a further aspect, the dynamic radius calculations performed during each model iteration, and the spheres having varying radii generated based on those calculations, permit enhanced data coverage with fewer spheres than might otherwise be required by other configurations. In a further aspect still, the model may use data points outside existing spheres to generate new spheres, to integrate spheres with one another, and/or to capture model mutations without requiring historical data for a particular customer metric. In an additional aspect, because the model ignores data points covered by previous iterations, the model may achieve a degree of accuracy and/or precision not attained by other configurations. Furthermore, it should be appreciated that the reduced computational complexity of the model may minimize storage space (e.g., in memory) needed to save model data. Finally, the model may offer improved simplicity for the calculation of anomaly scores based on distances to nearest neighboring spheres.

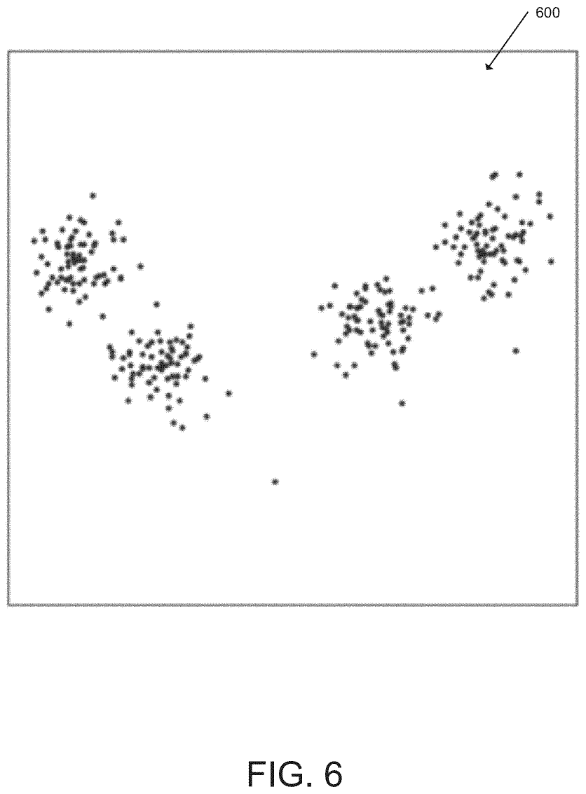

Referring now to FIG. 6, a collection 600 of metric data points/observations are shown after feature selection and prior to data analysis and generation of spheres based on the INS model. In the illustrative embodiment, the representation of the metric data points shown in FIG. 6 is associated with, or otherwise corresponds to, a representation following standardization of model features (e.g., a representation following performance of block 408 by the system). Additionally, in the illustrative example, the collection 600 of data points includes approximately 288 points collected over one day. Of course, it should be appreciated that in other examples, the collection 600 may include another suitable number of data points collected over another suitable time period.

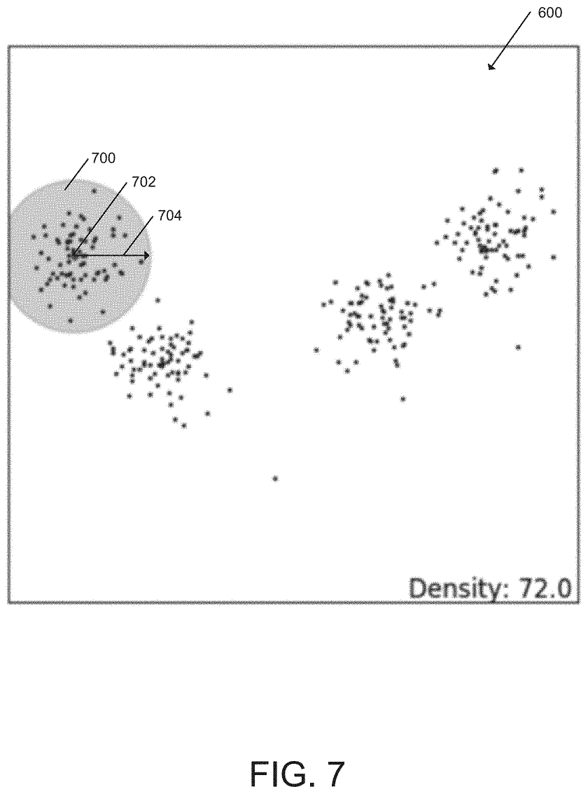

Referring now to FIG. 7, based on the collection 600 of data points/observations, at least one iteration of the INS model by the system (e.g., according to methods 300, 400, 500) generates a sphere 700 having a center 702 and a radius 704. In the illustrative example, the center 702 is located at the maximum concentration/density of data points inside the sphere 700 with the minimum sphere radius. Furthermore, in the illustrative example, the sphere 700 provides coverage of approximately 25% of the data points in the collection 600. In some embodiments, larger spheres may be indicative of dominant behaviors that involve multiple single behaviors.

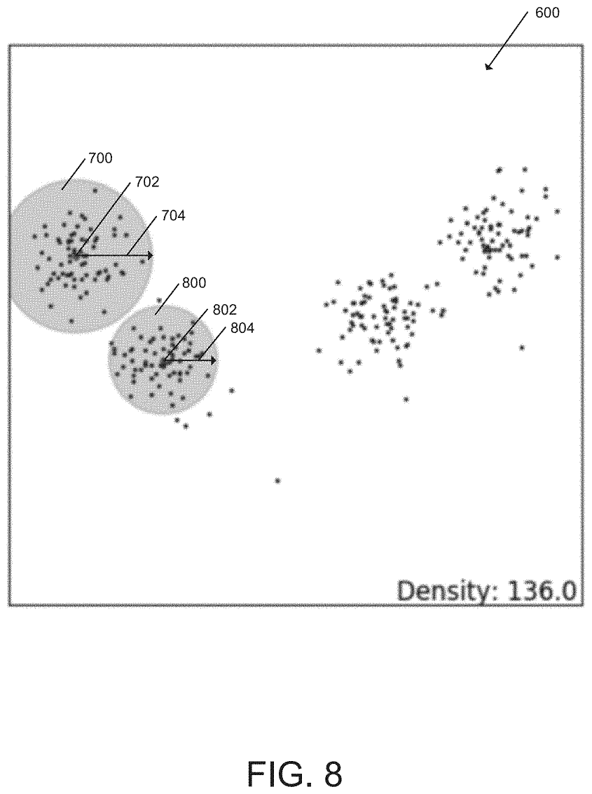

Referring now to FIG. 8, based on the collection 600 of data points/observations, multiple iterations of the INS model by the system (e.g., according to methods 300, 400, 500) generate another sphere 800 having a center 802 and a radius 804. In the illustrative example, the radius 804 is different from, and less than, the radius 704, and the spheres 700, 800 are spaced from one another. Additionally, in the illustrative example, the center 802 is located at the maximum concentration/density of data points inside the sphere 800. Finally, in the illustrative example, the spheres 700, 800 cooperatively provide coverage of approximately 47% of the data points in the collection 600.

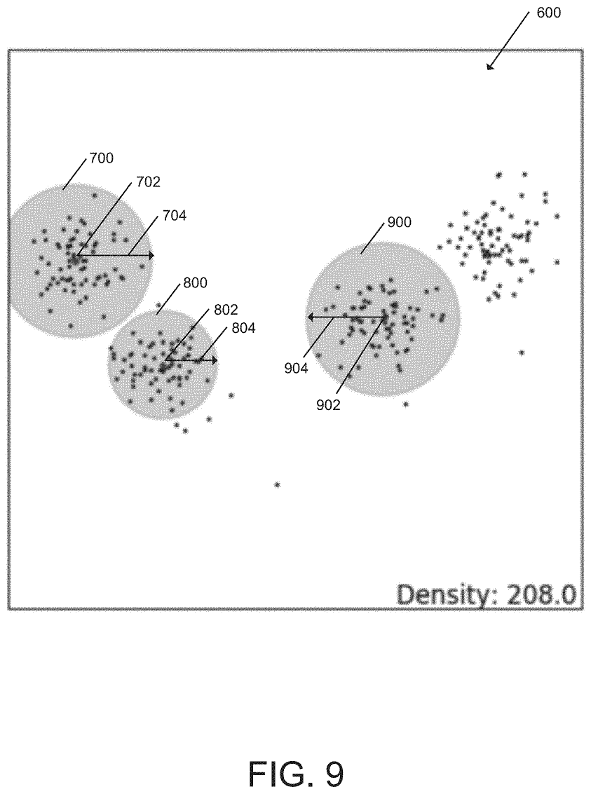

Referring now to FIG. 9, based on the collection 600 of data points/observations, multiple iterations of the INS model by the system (e.g., according to methods 300, 400, 500) generate another sphere 900 having a center 902 and a radius 904. In the illustrative example, the radius 904 is different from, and greater than, the radius 804, and the spheres 700, 800, 900 are spaced from one another. Additionally, in the illustrative example, the center 902 is located at the maximum concentration/density of data points inside the sphere 900. Finally, in the illustrative example, the spheres 700, 800, 900 cooperatively provide coverage of approximately 72% of the data points in the collection 600.

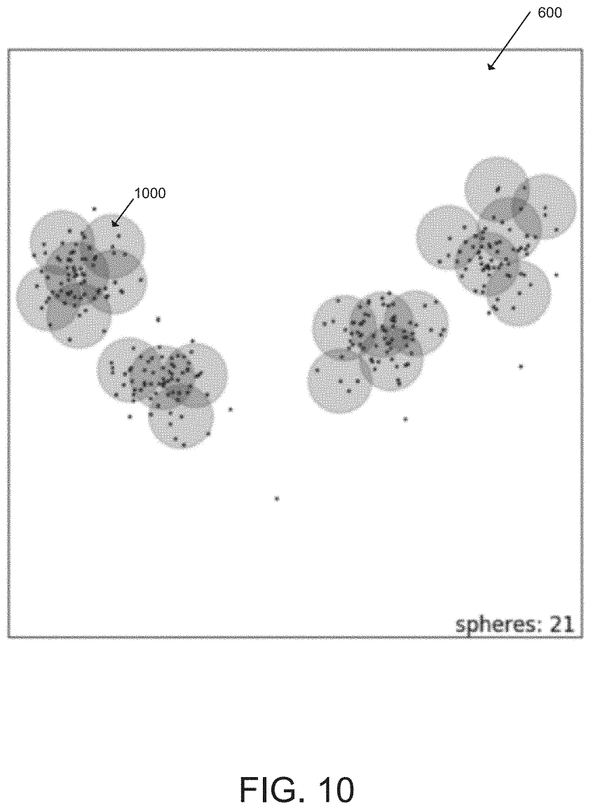

Referring now to FIG. 10, based on the collection 600 of data points/observations, execution of a comparative model different from the INS model (e.g., according to methods different from the illustrative methods 300, 400, 500) generates a set 1000 of spheres each having the same radius. In the comparative example, the set 1000 includes 21 spheres.

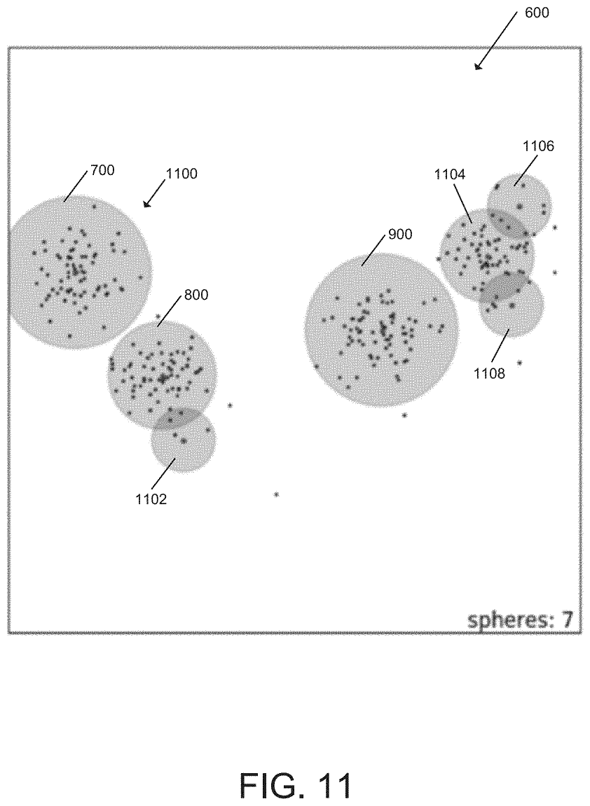

Referring now to FIG. 11, based on the collection 600 of data points/observations, multiple iterations of the INS model by the system (e.g., according to methods 300, 400, 500) generate a set 1100 of spheres having varying radii. In the illustrative example, the set 1100 includes 7 spheres (i.e., spheres 700, 800, 900, 1102, 1104, 1106, 1108). In at least some cases, using fewer spheres, the set 1100 provides equal to, or better, coverage of the collection 600 than the set 1000.

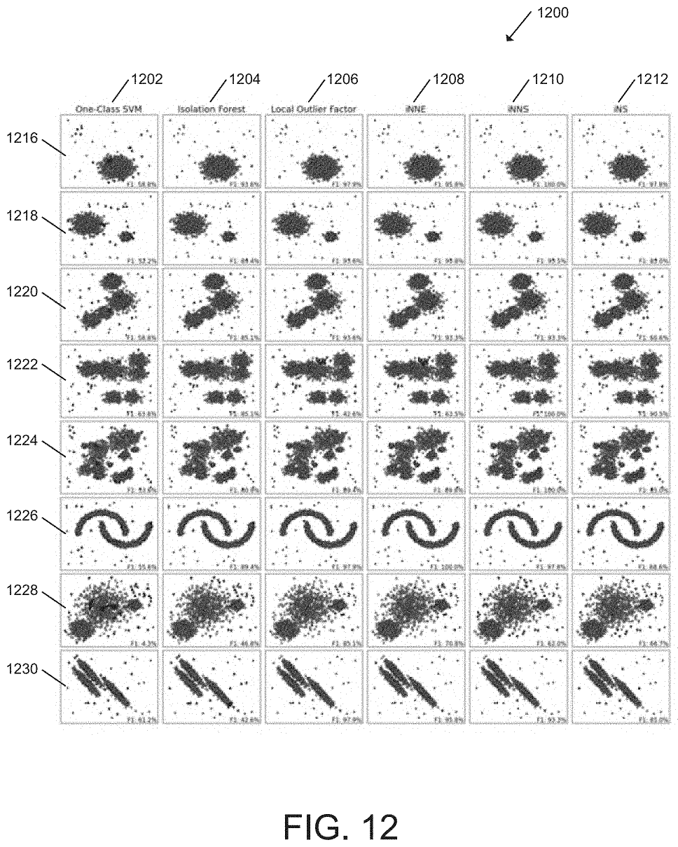

Referring now to FIG. 12, a performance evaluation 1200 illustrates the performance of the INS model compared to other algorithms based on various data sets. The represented models/algorithms include (i) one-class SVM 1202, (ii) isolation forest (iForest) 1204, (iii) local outlier factor 1206, (iv) isolation nearest neighbor ensemble (iNNE) 1208, (v) isolation nearest spheres with constant sphere radius (INSS) 1210, and (vi) isolation nearest spheres with variable sphere radii 1212 (corresponding to the INS model). The data sets include data sets 1216, 1218, 1220, 1222, 1224, 1226, 1228, 1230 with introduced anomalies. The evaluation 1200 shows characteristics of different anomaly detection models/algorithms on two-dimensional data sets. The data sets may contain one or two modes (regions of high density) to illustrate the ability of the models/algorithms to cope with multimodal data, at least in some embodiments.

For each data set 1216, 1218, 1220, 1222, 1224, 1226, 1228, 1230, one percent of samples may be generated as random noise and considered as outliers, at least in some embodiments. Data points in those data sets may be designated by (a) circles (i.e., corresponding to normal samples detected as normal), (b) starts (i.e., corresponding to outliers detected as outliers), (c) triangle up (i.e., corresponding to outliers detected as normal samples), and (d) triangle down (i.e., corresponding to normal samples detected as outliers).

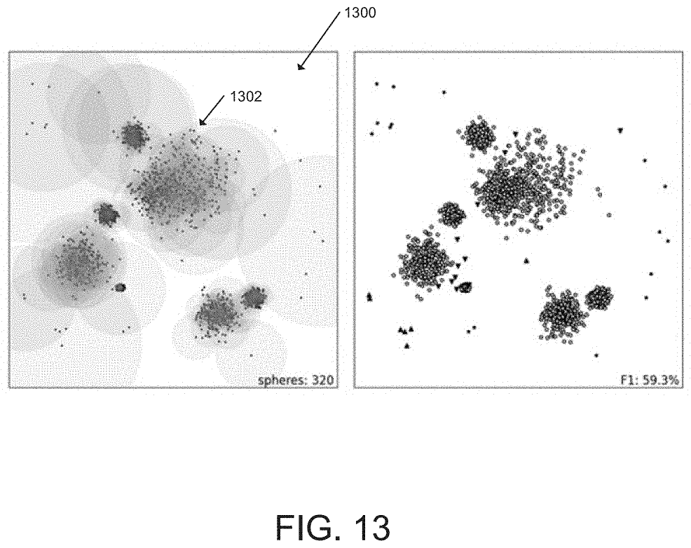

Referring now to FIG. 13, based on a collection 1300 of data points/observations, execution of a comparative model different from the INS model (iNNE) (e.g., according to methods different from the illustrative methods 300, 400, 500) generates a set 1302 of spheres. In the comparative example, the set 1302 may include 320 spheres. Additionally, in the comparative example, the set 1302 of spheres may be associated with an F1-score of 59.3%.

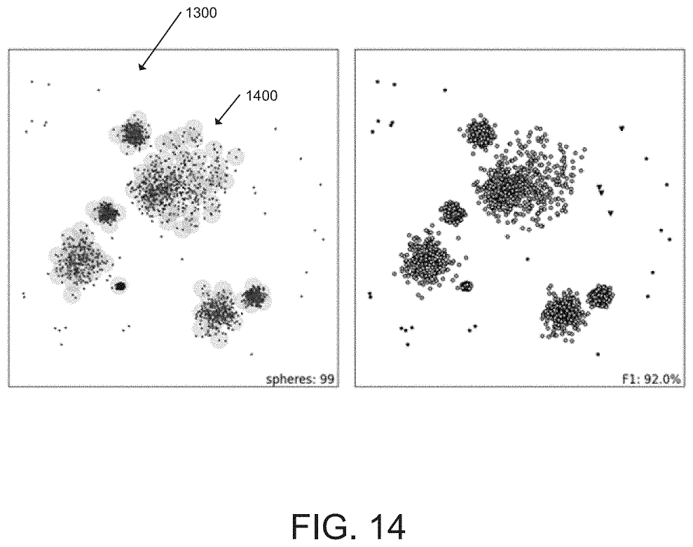

Referring now to FIG. 14, based on the collection 1300 of data points/observations, multiple iterations of the INS model by the system (e.g., according to methods 300, 400, 500) generate a set 1400 of spheres. In the illustrative example, the set 1400 may include 99 spheres. Additionally, in the illustrative example, the set 1400 of spheres may be associated with an F1-score of 92.0%.

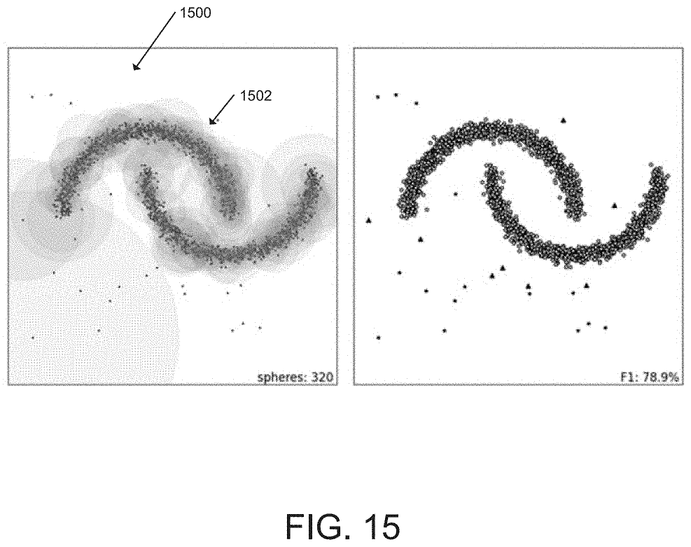

Referring now to FIG. 15, based on a collection 1500 of data points/observations, execution of a comparative model different from the INS model (iNNE) (e.g., according to methods different from the illustrative methods 300, 400, 500) generates a set 1502 of spheres. In the comparative example, the set 1502 may include 320 spheres. Additionally, in the comparative example, the set 1502 of spheres may be associated with an F1-score of 78.9%.

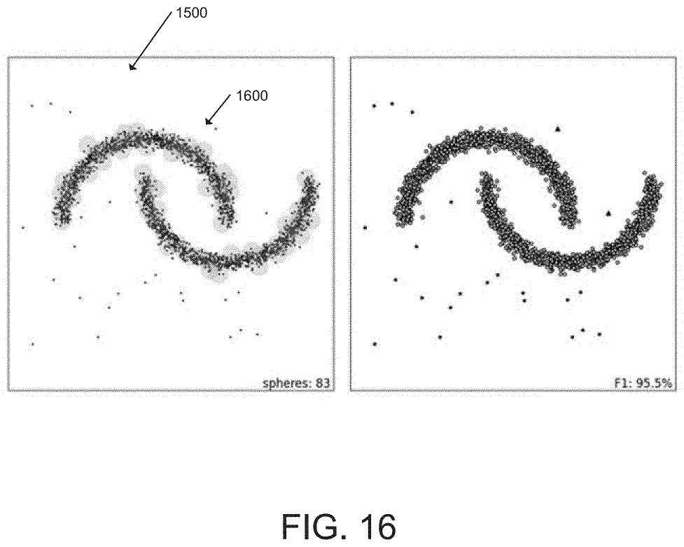

Referring now to FIG. 16, based on the collection 1500 of data points/observations, multiple iterations of the INS model by the system (e.g., according to methods 300, 400, 500) generate a set 1600 of spheres. In the illustrative example, the set 1600 may include 83 spheres. Additionally, in the illustrative example, the set 1600 of spheres may be associated with an F1-score of 95.5%.

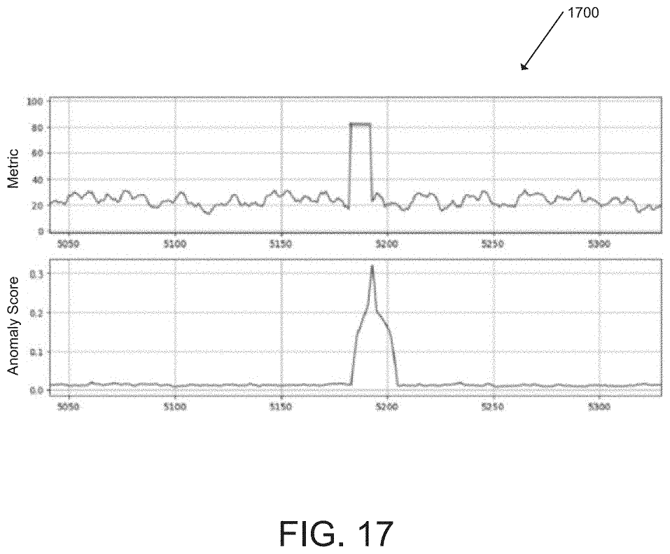

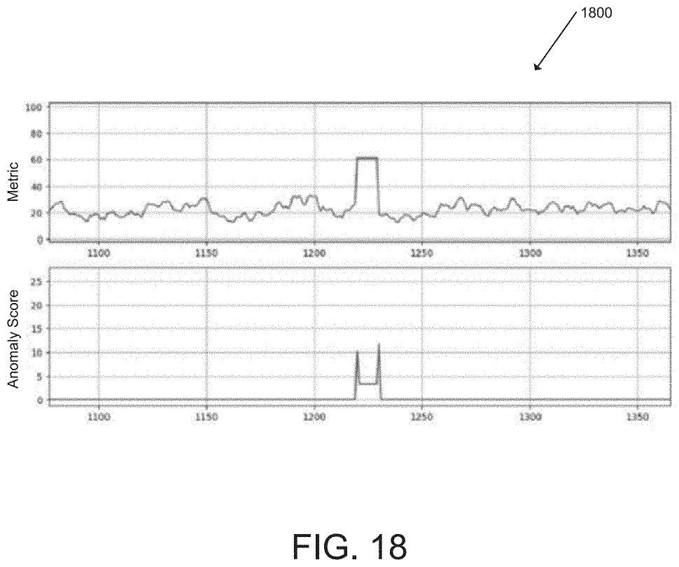

Referring now to FIGS. 17 and 18, a set of comparative graphs 1700 are associated with execution of a comparative model different from the INS model and a set of graphs 1800 are associated with execution of the INS model.

In some embodiments, a method for automatically detecting anomalies in continuously monitored components may include
while the component operates, continually monitoring data points from performance counters comprising receiving, by a processor of a computing device, data points comprised in a time series generated by the component, wherein the data points are data points of performance counters and wherein the data points are not labeled as normal or abnormal before being processed;
detecting anomalies within the time series in the absence of labeled data defining anomalous data and in the absence of labeled data defining normal data;
post-processing of the raised anomaly events to aggregate anomaly events by combining anomaly events raised for a single data point in multiple processing paths into a single event which carries all the identifiers of the processing paths in which it was detected, wherein each processing path identifier corresponds to the respective type of anomaly; and
provide information about whether the component is operating properly or is malfunctioning, enabling notification of an owner or operator of the component of the anomalous behavior of the component at the time it occurs;
wherein detecting anomalies within the time series comprises detecting a score of abnormality of one sample with the scores of its neighbors in accordance with an Isolation Nearest Spheres algorithm.

What is claimed is:

1. A system for detecting anomalies in metric data provided by one or more customers, the system comprising:
at least one processor; and
at least one memory comprising a plurality of instructions stored thereon that, in response to execution by the at least one processor, causes the system to:
receive metric data indicative of a plurality of time-series based observations for a particular customer metric;
define, based on the metric data, a plurality of parameters to characterize one or more spheres each configured to capture a number of time-series based observations for the particular customer metric; and
generate, based on the plurality of parameters, the one or more spheres to determine coverage of the metric data within the one or more spheres and detect one or more anomalies in the metric data,
wherein to generate the one or more spheres based on the plurality of parameters comprises to dynamically generate a plurality of spheres each having a radius that varies based on the plurality of time-series based observations for the particular customer metric.

2. The system of claim 1, wherein to define the plurality of parameters based on the metric data comprises to:
define a minimum radius for generation of at least one sphere;
define a radius increment for generation of one or more new spheres each having a varying radius; and
define a coverage limit indicative of a maximum number of metric data points to be covered by the generated spheres.

3. The system of claim 2, wherein to generate the one or more spheres based on the plurality of parameters comprises to determine a location corresponding to a maximum concentration of metric data based on the minimum radius.

4. The system of claim 3, wherein to generate the one or more spheres based on the plurality of parameters comprises to:
determine whether the coverage limit has been reached; and
increment a radius for generation of at least one new sphere based on the radius increment in response to a determination that the coverage limit has not been reached.

5. The system of claim 4, wherein to generate the one or more spheres based on the plurality of parameters comprises to:
determine whether the at least one new sphere provides coverage of the metric data not previously provided; and
filter out metric data already covered by a previous sphere in response to a determination that the at least one new sphere does not provide coverage of the metric data not previously provided.

6. The system of claim 4, wherein to generate the one or more spheres based on the plurality of parameters comprises to:
update the minimum radius in response to a determination that the at least one new sphere provides coverage of the metric data not previously provided; and
update the location in response to the determination that the at least one new sphere provides coverage of the metric data not previously provided.

7. The system of claim 3, wherein to generate the one or more spheres based on the plurality of parameters comprises to:
determine another location corresponding to the maximum concentration of metric data based on the minimum radius of the at least one sphere and a distance between the at least one sphere and at least one nearest neighboring sphere; and
generate at least one new sphere such that a center of the at least one new sphere is positioned at the another location.

8. The system of claim 7, wherein to generate the one or more spheres based on the plurality of parameters comprises to:
compare coverage of the metric data provided by the at least one sphere to coverage of the metric data provided by the at least one nearest neighboring sphere or the at least one new sphere; and
select whichever sphere provides the greatest coverage of the metric data based on the comparison for generation of another new sphere.

9. The system of claim 2, wherein to define the plurality of parameters based on the metric data comprises to:
filter out outliers from the metric data; and
define the coverage limit based at least partially on the filtered metric data.

10. One or more non-transitory machine-readable storage media comprising a plurality of instructions stored thereon that, in response to execution by at least one processor, causes a system to:
receive metric data indicative of a plurality of time-series based observations for a particular customer metric;
define, based on the metric data, a plurality of parameters to characterize one or more spheres each configured to capture a number of time-series based observations for the particular customer metric; and
generate, based on the plurality of parameters, the one or more spheres to determine coverage of the metric data within the one or more spheres and detect one or more anomalies in the metric data,
wherein to generate the one or more spheres based on the plurality of parameters comprises to dynamically generate a plurality of spheres each having a radius that varies based on the plurality of time-series based observations for the particular customer metric.

11. The one or more non-transitory machine-readable storage media of claim 10, wherein to define the plurality of parameters based on the metric data comprises to:
define a minimum radius for generation of at least one sphere;
define a radius increment for generation of one or more new spheres each having a varying radius; and
define a coverage limit indicative of a maximum number of metric data points to be covered by the generated spheres.

12. The one or more non-transitory machine-readable storage media of claim 11, wherein to generate the one or more spheres based on the plurality of parameters comprises to determine a location corresponding to a maximum concentration of metric data based on the minimum radius.

13. The one or more non-transitory machine-readable storage media of claim 12, wherein to generate the one or more spheres based on the plurality of parameters comprises to:
determine whether the coverage limit has been reached; and
increment a radius for generation of at least one new sphere based on the radius increment in response to a determination that the coverage limit has not been reached.

14. The one or more non-transitory machine-readable storage media of claim 13, wherein to generate the one or more spheres based on the plurality of parameters comprises to:
determine whether the at least one new sphere provides coverage of the metric data not previously provided; and
filter out metric data already covered by a previous sphere in response to a determination that the at least one new sphere does not provide coverage of the metric data not previously provided.

15. The one or more non-transitory machine-readable storage media of claim 13, wherein to generate the one or more spheres based on the plurality of parameters comprises to:
update the minimum radius in response to a determination that the at least one new sphere provides coverage of the metric data not previously provided; and
update the location in response to the determination that the at least one new sphere provides coverage of the metric data not previously provided.

16. The one or more non-transitory machine-readable storage media of claim 11, wherein to define the plurality of parameters based on the metric data comprises to:
filter out outliers from the metric data; and
define the coverage limit based at least partially on the filtered metric data.

17. A method of detecting anomalies in metric data provided by one or more customers, the method comprising:
receiving, by a contact center system or a compute device, metric data indicative of a plurality of time-series based observations for a particular customer metric;
defining, by the contact center system or the compute device based on the metric data, a plurality of parameters to characterize one or more spheres each configured to capture a number of time-series based observations for the particular customer metric; and
generating, by the contact center system or the compute device based on the plurality of parameters, the one or more spheres to determine coverage of the metric data within the one or more spheres and detect one or more anomalies in the metric data,
wherein generating the one or more spheres based on the plurality of parameters comprises dynamically generating, by the contact center system or the compute device, a plurality of spheres each having a radius that varies based on the plurality of time-series based observations for the particular customer metric.

18. The method of claim 17, wherein defining the plurality of parameters based on the metric data comprises:
defining, by the contact center system or the compute device, a minimum radius for generation of at least one sphere;
defining, by the contact center system or the compute device, a radius increment for generation of one or more new spheres having a varying radius; and
defining, by the contact center system or the compute device, a coverage limit indicative of a maximum number of metric data points to be covered by the generated spheres.

19. The method of claim 18, wherein generating the one or more spheres based on the plurality of parameters comprises determining, by the contact center system or the compute device, a location corresponding to a maximum concentration of metric data based on the minimum radius.

20. The method of claim 19, wherein generating the one or more spheres based on the plurality of parameters comprises:
determining, by the contact center system or the compute device, whether the coverage limit has been reached; and
incrementing, by the contact center system or the compute device, a radius for generation of at least one new sphere based on the radius increment in response to a determination that the coverage limit has not been reached.
